(19) United States
(12) Patent Application Publication
(10) Pub. No.: US 2013/0110986 A1
(43) Pub. Date: May 2, 2013

(54) MOBILE WIRELESS COMMUNICATION SYSTEM

(71) Applicant: Rajan VERMA, Toronto (CA)

(72) Inventor: Rajan VERMA, Toronto (CA)

(73) Assignee: AAJO Systems, Inc., Toronto (CA)

(21) Appl. No.: 13/663,074

(22) Filed: Oct. 29, 2012

Related U.S. Application Data
(60) Provisional application No. 61/553,277, filed on Oct. 31, 2011.

(51) Int. Cl. H04W 8/24

(52) U.S. Cl. CPC H04W 8/245
USPC 709/219

(57) ABSTRACT

A mobile wireless communication system including a mobile device having a plurality of interface elements, a query server configured to obtain data from the mobile device and generate a processed data and a content server configured to store a multimedia content. The content server is configured to obtain the processed data from the query server and choose the multimedia content according to the processed data and the multimedia content chosen according to the processed data configured to be wirelessly transmitted to the mobile device and alter at least one of the plurality of interface elements.

### CROSS REFERENCE TO RELATED APPLICATION

This application claims priority to U.S. Provisional Application 61/553,277, filed Oct. 31, 2011, the disclosure of which is considered part of and is incorporated herein by reference in its entirety.

### FIELD OF THE INVENTION

The present invention relates to mobile wireless communication systems and more particularly to the method of advertising using a mobile wireless communication system.

### BACKGROUND

The following publications are believed to represent the current state of the art:

U.S. Pat. Nos. 7,177,938; 7,027,801; 7,589,628; 5,852,775;

### U.S. Patent Publication Nos. 2008/0133336;

International Patent and Publication Nos. WO2010015070; EP1895750; WO2009005865. WO2009079385; EP1135939.

### SUMMARY

The present invention seeks to provide a mobile wireless communication system with improved capabilities.

There is thus provided in accordance with a preferred embodiment of the invention that a mobile wireless communication system including a mobile device having a plurality of interface elements, a query server configured to obtain data from the mobile device and generate a processed data and a content server configured to store a multimedia content.

The content server is configured to obtain the processed data from the query server and choose the multimedia content according to the processed data and the multimedia content chosen according to the processed data configured to be wirelessly transmitted to the mobile device and alter at least one of the plurality of interface elements.

There is further provided in accordance with a preferred embodiment of the invention that a method for altering mobile device interface elements including the steps of: providing a mobile device having a plurality of interface elements, providing a query server configured to obtain data from the mobile device and generate a processed data, providing a content server configured to store a multimedia content.

The content server is configured to obtain the processed data from the query server and choose the multimedia content according to the processed data and the multimedia content chosen according to the processed data configured to be wirelessly transmitted to the mobile device and alter at least one of the plurality of interface elements.

There is further yet provided in accordance with a preferred embodiment of the invention that a mobile wireless communication device including a mobile device having a plurality of interface elements and a software configured to be associated with the mobile device. The software is configured to obtain data from at least one remote server and is configured to alter at least one of the plurality of interface elements according to the data obtained from the at least one remote server. The software is further configured to preclude the mobile device user from changing the at least one of the plurality of interface elements altered according to the data obtained from the at least one remote server.

There is further yet provided in accordance with a preferred embodiment of the invention that a method for altering mobile device interface elements including the steps of:

providing a mobile device having a plurality of interface elements,
providing a software configured to obtain data from at least one remote server.
The software is configured to alter at least one of the plurality of interface elements according to the data obtained from the at least one remote server. The software is further configured to preclude the mobile device user from changing the at least one of the plurality of interface elements altered according to the data obtained from the at least one remote server.

There is further yet provided in accordance with a preferred embodiment of the invention that a method of providing renting advertising space, including the steps of: providing a mobile device having a plurality of interface elements and a software configured to be associated with the mobile device, the software is configured to alter the mobile device interface elements. The interface elements are configured to be altered according to data provided by a remote server and the mobile device user compensation is calculated based on the amount of interface element alternations.

### BRIEF DESCRIPTION OF THE DRAWINGS

The present invention will be understood and appreciated more fully from the following detailed description, taken in conjunction with the drawings in which:

FIG. 1 is a simplified block diagram illustration of a mobile wireless communication system constructed and operative in accordance with a preferred embodiment of the invention;

FIG. 2 is a simplified pictorial illustration of the updated interface elements on the mobile device in accordance to one example of the invention.

FIG. 3 is a simplified pictorial illustration of the updated interface elements on the mobile device in accordance to another example of the invention.

FIG. 4 is a simplified pictorial illustration of the updated interface elements on the mobile device in accordance to yet another example of the invention.

FIG. 5 is a simplified pictorial illustration of the updated interface elements on the mobile device in accordance to yet another example of the invention.

FIG. 6 is a simplified flow chart illustration of the server instance operation of the mobile wireless communication system of FIG. 1;

FIG. 7 is a simplified flow chart illustration of the client instance operation of the mobile wireless communication system of FIG. 1;

FIG. 8 is a simplified flow chart illustration of the communication process of the mobile wireless communication system of FIG. 1;

FIG. 9 is a simplified flow chart illustration of the business model in accordance with a preferred embodiment of the invention.

### DETAILED DESCRIPTION

The embodiments of the present invention relate to a mobile wireless communication system, such as for example, a cellular phone, a tablet, a net book, a smartphone, an electronic book reader or any other type of mobile or portable electronic device which can communicate with other devices wirelessly.

It is appreciated that wireless communication can be executed by cell phone technology, WIFI, WAP, Bluetooth or any other type of wireless data transmission.

The embodiments of the present invention comprise a method of providing a focused promotion or advertisement material through a mobile device, using the mobile device as a promotional platform.

The mobile device may have a plurality of interface elements, which may be the inherent features of the mobile device, such as a ringtone, background image, power up image, speed dial memory, messaging system, main screen image, chat session image, alarm clock ringer, mobile web session homepage or any other inherent feature defined within the operating system of the mobile device.

The mobile device may further have an internal GPS (Global Positioning System) that provides the location of the mobile device.

The mobile device may additionally store a user profile details, such as for example, age, sex, interests, health condition, dietary preference.

In accordance to the embodiments of the present invention, a remote server is provided, which preferably contains a database with all the promotional content to be delivered to the target mobile device user.

The embodiments of the present invention more specifically relate to a method to effectively display promotional content of associated brand partners on the mobile device by pushing or sending content to the at least one of the plurality of the interface elements of the mobile device. The associated brand partners may include any company in business relations with the mobile wireless communication system owner.

The method described in detail herein below relates to an automatic alteration of the mobile device interface elements, based on the mobile device location, time and user profile. The promotional content of the associated brand partners according to the embodiments of the present invention does not depend on the activity of the mobile device user, rather it may be securely updated dynamically. The plurality of the interface elements may be locked from user manipulation and updated automatically with promotional content from the remote server, in accordance to the device location, time and user profile.

The wireless communication system is described with respect to a single mobile device user, however, it is appreciated that the system is adapted to be employed for multiple mobile device users and a plurality of queries and data packages may be created and sent simultaneously.

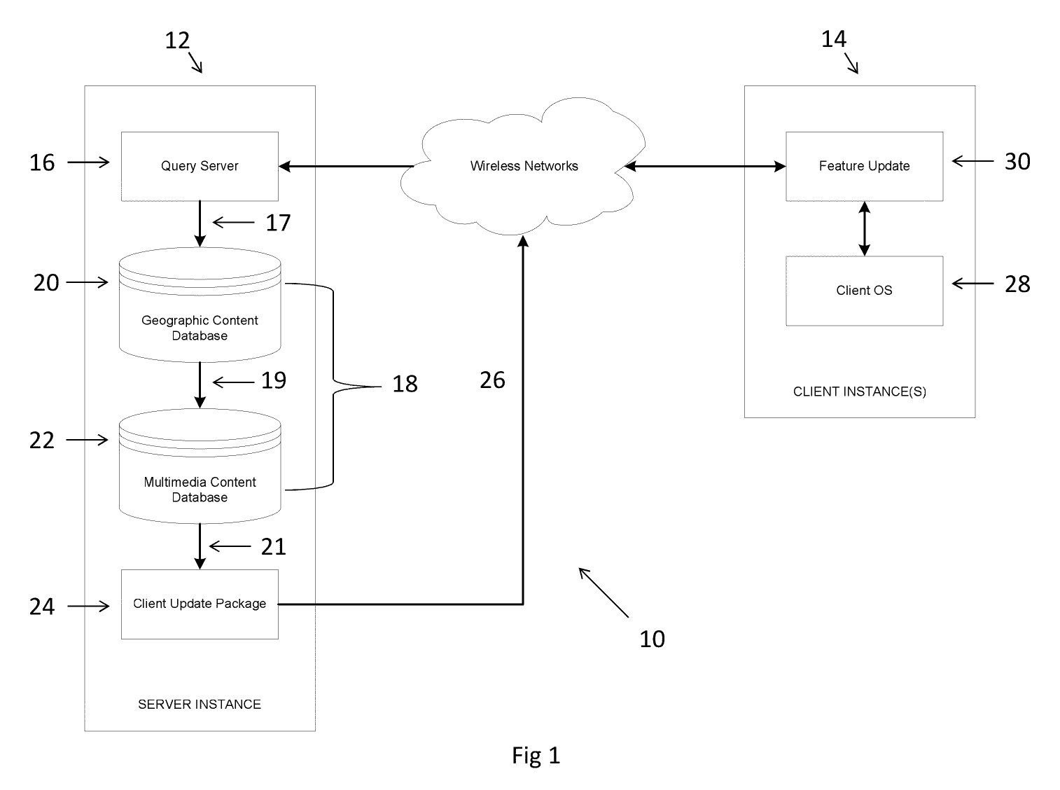

Reference is now made to FIG. 1, which is a simplified block diagram illustration of a mobile wireless communication system constructed and operative in accordance with a preferred embodiment of the invention;

As seen in FIG. 1, there is provided a wireless communication system 10, which is configured to communicate with a server instance 12, comprised of a plurality of elements, which will be described in detail herein below. The wireless communication system 10 is further configured to communicate with at least one client instance 14, which may be for example, the mobile device.

The server instance 12 is configured to wirelessly communicate with the at least one client instance 14 through a proprietary native code modification of an existing mobile operating system commercially available such as Android available from Google Inc, US or through a dedicated operating system.

The server instance 12 may preferably contain a query server 16 and a content server 18 including all promotional content, such as geographic content database 20 and a multimedia content database 22.

The server instance 12 is additionally adapted to convert the content received from the mobile device user, such as user profile, location and time, to the format suitable for the content server.

Each mobile device operating system may be either modified or a proprietary operating system, as mentioned below, which enables the automatic alteration of the interface elements of the mobile device.

The query server 16 serves as the initiating source for the server structure and it can be either invoked by a mobile device user or may execute without any input from the mobile device user. The query server 16 is configured to collect location, time and user profile data from the mobile device user and prepare this data as input to the content servers 18. This preparation may involve normalization of the data for optimization of the geographic content database 20 and the multimedia content database 22 queries.

The query server 16 may execute a search string 17, which may be inputted into the Geographic content database 20 and interpret the geographic location of the mobile device. The geographic content database 20 may contain the locations of the associated brand partners.

The geographic content database 20 is configured to execute a proprietary weighted search factor and create a list 19 of associated brand partners and the type of the associated features that may be packaged and sent to the mobile device user based on proximity to him. The list 19 is adapted to be inputted to the multimedia content database 22.

The multimedia content database 22 may store the contents of the associated brand partners. The contents stored in the multimedia content database 22 may include jingles, logos, trademarks, company pictures, advertisement propositions or any other type of promotional material. The content may be stored in the multimedia content database 22 in various formats, resolutions and file types, such that it corresponds to the target mobile device and the modified or proprietary operating system 28, as shown in the client instance 14.

Suitable media is searched within the multimedia content server 22, based on the proximity of the mobile device user, time of the day and user profile data. Suitable media may be further searched within the multimedia content server 22 based on the amount of times that the promotional content of a specific associated brand partner has been received by the mobile device user.

A set of media files 21 may be produced within the multimedia content database 22 and may be sent to the client update package 24 process. The client update package 24 process may compress the set of media files 21 and prepare it for simplified wireless transmission. The promotional content contained in the set of media files 21 may be sent to the target client instance 14 and the client update package 24 may be adapted to track the amount of times that the promotional content of a specific associated brand partner has been sent.

In accordance with the embodiments of the present invention, the client instance 14, which may be the mobile device as mentioned above, may have proprietary software and hardware, which are adapted to receive data 26 outputted from the server instance 12 and perform as display mechanism for the promotional content.

The mobile device may be equipped with a commercially available operating system 28, a modified operating system or a dedicated operating system.

The data 26 received by the mobile device may be interpreted by the operating system of the mobile device or may be alternatively interpreted by on-board hardware device or by a chip.

The operating system 28 options may be programmed to lock at least one of the plurality of interface elements from user manipulation.

The mobile device 14 may be updated through the feature update 30 process. The feature update 30 may be operative in several different ways. For example, the feature update 30 may invoke the server instance 12 to start a search or it may alternatively act as a passive receiver, such that it may be configured to receive the data 26 from the server instance 12.

The operating system 28 of the client instance 12 may be configured to enable the mobile device user manually request the data 26 from the server instance 12 through a software configured button or a reconfigurable hardware button on the mobile device.

In accordance to the embodiments of the present invention, the data 26 provides a unique update package, which is configured to be sent to the target mobile device.

The feature update 30 is configured to decrypt and decompress the data 26, it is further configured to delete previous content, automatically install the data 26, which may be for example multimedia promotional content and alter or reconfigure the applicable locked interface elements, such as a ringtone, background image, power up image, speed dial memory, messaging system or any other inherent feature defined within the operating system 28 of the client instance 14, which can be for example a mobile device.

The feature update 30 process may be configured to automatically alter the interface elements through a dedicated process, channel or thread in order to ensure that the quality of the mobile device service is not hindered.

### Example 1

The process flow of the feature update 30 process invoked by the server instance 12 is exemplified herein.

| Step | | | | |
|---|---|---|---|---|
| no. | Executing Process | Description | Input | Output |
| 1 | Server instance (12) - | The query server 16 process may be | Time | Send |
| | Query server (16) | configured to provide updates to the mobile | | request for |
| | | device based on elapse of time or time of | | location |
| | | the day. The query server 16 will request | | from the |
| | | the location of the mobile device every | | client |
| | | predetermined period of time. | | instance 14 |
| 2 | Client instance (14) - | Feature update 30 may be configured to | Query server | The client |
| | Feature Update (30) | handle the request from the query server 16 | 16 request | instance 14 |
| | | and collect data from the internal GPS of | | sends the |
| | | the mobile device. | | mobile |
| | | | | device |
| | | | | location to |
| | | | | the query |
| | | | | server 16 |
| 3 | Server instance (12) - | The query server 16 may be configured to | Mobile user | Encoded |
| | query server (16) | create a search string 17 adapted to be | identification | search |
| | | provided to the geographic content database | and | string 17 |
| | | 19. The search string 17 may be based on | geographic | for |
| | | the user profile associated with the mobile | location from | geographic |
| | | device and on the geographic location. | the client | content |
| | | | instance 14 | database 20 |
| 4 | Server instance (12) - | The geographic content database 19 may be | Query server | List of |
| | Geographic | configured to provide weighted list 19 of | 16 search | contents of |
| | content database | associated brand partners to be used for the | string 17 | associated |
| | (19) | mobile device interface elements update, | | brand |
| | | such as for example, multimedia feature | | partners |
| | | update. | | |
| 5 | Server instance (12) - | The multimedia content database 22 may be | List of | Set of |
| | Multimedia | searched and is configured to output set of | contents of | media files |
| | content database | media files 21, which include the correct | associated | 21, such as |
| | (22) | format of the contents of associated brand | brand partners | multimedia |
| | | partners, such as ringtones, images, logos or | | update |
| | | any other type of promotional material. | | package |
| 6 | Server Instance (12) - | Client update package 24 is configured to | Set of media | Send the |
| | Client update | receive the set of media files 21, such as any | files 21, such | data 26, |
| | package (24) | multimedia content, further configured to | as multimedia | such as |
| | | compress it, encrypt and send the data 26 to | update | multimedia |
| | | the target client instance 14. | package | update |
| | | | | package to |
| | | | | the target |
| | | | | client |
| | | | | instance 14 |
| 7 | Client instance (14) - | The feature update 30 process is configured | Data 26, such | Altered |
| | Feature update | to be built into the operating system 28 and | as multimedia | interface |
| | (30) | is further configured to receive the data 26, | update | elements, |
| | | such as multimedia update package, to | package | for |
| | | decrypt, decompress and delete old features | received from | example |
| | | and install new features into the mobile | the server | new feature |
| | | device, while altering interface elements of | instance 12 | such as |
| | | the mobile device. | | ringtones, |
| | | | | background |
| | | | | images |
| | | | | installed. |
| 8 | Client instance (14) - | The interface elements of the mobile device | Altered | NA |
| | operating system | are configured to be locked from the mobile | interface | |
| | (28) | device user manipulation and the | elements, for | |
| | | promotional information has been pushed to | example new | |
| | | target. | feature such | |
| | | | as ringtones, | |
| | | | background | |
| | | | images | |
| | | | installed. | |

### Example 2

The process flow of the feature update 30 process invoked by the client instance 14 is exemplified herein.

| Step | | | | |
|---|---|---|---|---|
| no. | Executing Process | Description | Input | Output |
| 1 | Client instance (14) - | The mobile device user invokes a | The input of | Execute |
| | Operating system (28) | command through software or | mobile device | interface |
| | | hardware requesting an update to the | user | elements |
| | | interface elements, such as mobile | | update, new |
| | | phone features. | | features are |
| | | | | configured to |
| | | | | be installed by |
| | | | | the feature |
| | | | | update 30 of |
| | | | | the client |
| | | | | instance 14 |
| 2 | Client instance (14) - | Feature update 30 may be configured | Update | The client |
| | Feature Update (30) | to send the user profile and the mobile | command | instance 14 |
| | | device location to the query server 16 | may be sent | sends the |
| | | of the server instance 12. | from the | mobile device |
| | | | operating | location and |
| | | | system 28 of | user profile to |
| | | | the client | the query |
| | | | instance 14 | server 16 |
| 3 | Server instance (12) - | The query server 16 may be | Mobile user | Encoded |
| | query server (16) | configured to create a search string 17 | identification | search string |
| | | adapted to be provided to the | and | 17 for |
| | | geographic content database 19. The | geographic | geographic |
| | | search string 17 may be based on the | location from | content |
| | | user profile associated with the mobile | the client | database 20 |
| | | device and on the geographic location. | instance 14 | |
| 4 | Server instance (12) - | The geographic content database 19 | Query server | List of contents |
| | Geographic content | may be configured to provide | 16 search | of associated |
| | database (19) | weighted list 19 of associated brand | string 17 | brand partners |
| | | partners to be used for the mobile | | |
| | | device interface elements update, | | |
| | | such as for example, multimedia | | |
| | | feature update. | | |
| 5 | Server instance (12) - | The multimedia content database 22 | List of | Set of media |
| | Multimedia content | may be searched and is configured to | contents of | files 21, such |
| | database (22) | output set of media files 21, which | associated | as multimedia |
| | | include the correct format of the | brand partners | update package |
| | | contents of associated brand partners, | | |
| | | such as ringtones, images, logos or | | |
| | | any other type of promotional | | |
| | | material. | | |
| 6 | Server Instance (12) - | Client update package 24 is | Set of media | Send the data |
| | Client update package | configured to receive the set of media | files 21, such | 26, such as |
| | (24) | files 21, such as any multimedia | as multimedia | multimedia |
| | | content, further configured to | update | update package |
| | | compress it, encrypt and send the data | package | to the target |
| | | 26 to the target client instance 14. | | client instance |
| | | | | 14 |
| 7 | Client instance (14) - | The feature update 30 process is | Data 26, such | Altered |
| | Feature update (30) | configured to be built into the | as multimedia | interface |
| | | operating system 28 and is further | update | elements, for |
| | | configured to receive the data 26, such | package | example new |
| | | as multimedia update package, to | received from | feature such as |
| | | decrypt, decompress and delete old | the server | ringtones, |
| | | features and install new features into | instance 12 | background |
| | | the mobile device, while altering | | images |
| | | interface elements of the mobile | | installed. |
| | | device. | | |
| 8 | Client instance (14) - | The interface elements of the mobile | Altered | NA |
| | operating system (28) | device are configured to be locked | interface | |
| | | from the mobile device user | elements, for | |
| | | manipulation and the promotional | example new | |
| | | information has been pushed to target. | feature such | |
| | | | as ringtones, | |
| | | | background | |
| | | | images | |
| | | | installed. | |

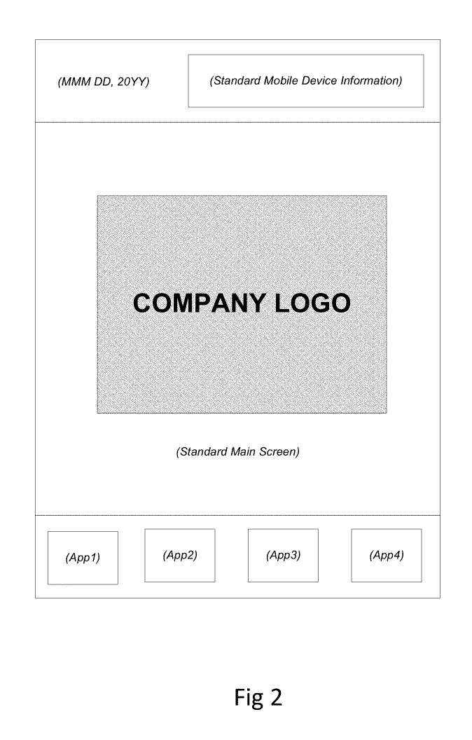

Reference is now made to FIG. 2, which is a simplified pictorial illustration of the updated interface elements on the mobile device in accordance to one example of the invention. It can be seen on FIG. 2, that the main screen of the targeted mobile device is updated with the updated multimedia package, such as for example a company logo of the associated brand partner.

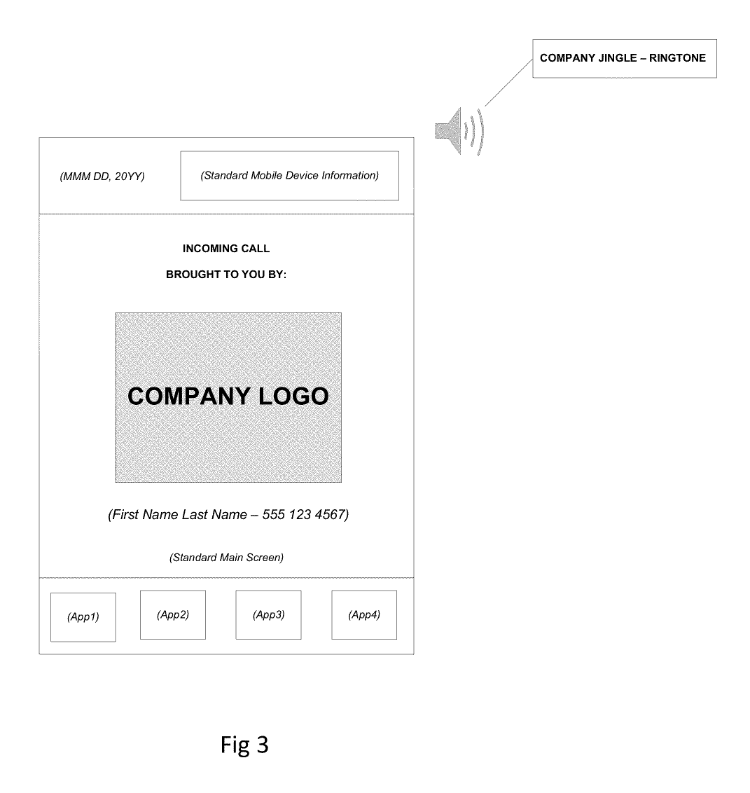

Reference is now made to FIG. 3, which is a simplified pictorial illustration of the updated interface elements on the mobile device in accordance to one example of the invention. It can be seen on FIG. 3, that the ringtone of the targeted mobile device is updated with the updated multimedia package, such as for example a company jingle of the associated brand partner and the company logo of the associated brand partner may be presented on the main screen of the targeted mobile device while an incoming call is received.

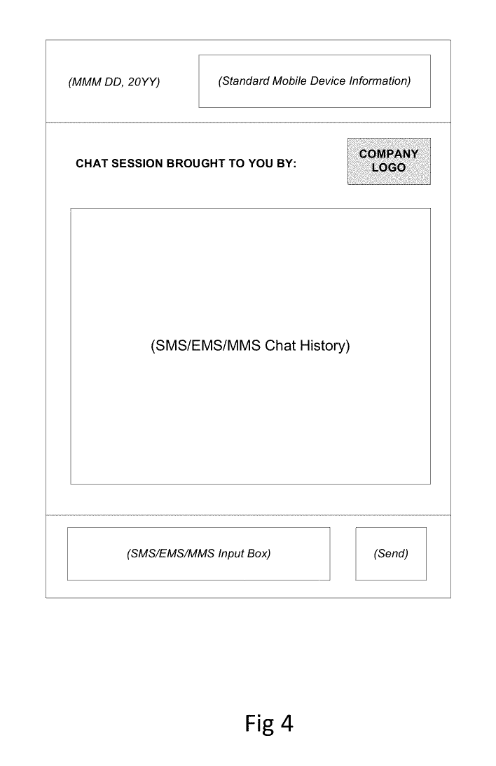

Reference is now made to FIG. 4, which is a simplified pictorial illustration of the updated interface elements on the mobile device in accordance to one example of the invention. It can be seen on FIG. 4, that the chat session of the targeted mobile device is updated with the updated multimedia package, such as for example a company logo of the associated brand partner may be presented beside the chat session.

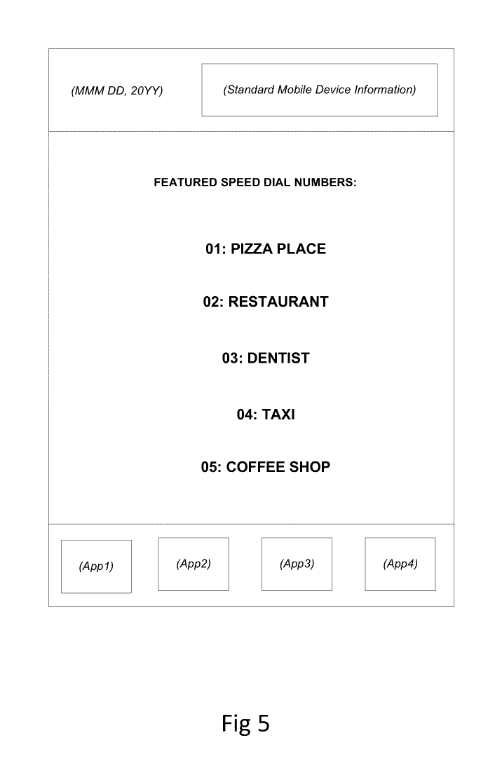

Reference is now made to FIG. 5, which is a simplified pictorial illustration of the updated interface elements on the mobile device in accordance to one example of the invention. It can be seen on FIG. 5, that the speed dials of the targeted mobile device are updated with the updated multimedia package, such as for example a company phone number of the associated brand partner.

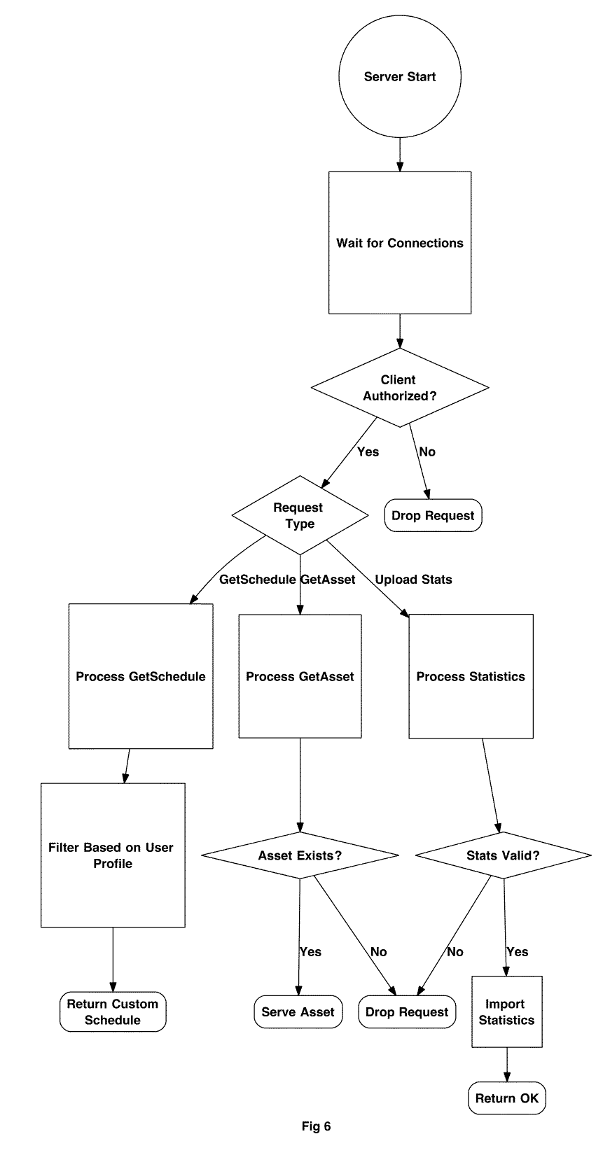

Reference is now made to FIG. 6, which is a simplified flow chart illustration of the server instance operation of the mobile wireless communication system of FIG. 1.

It can be seen in FIG. 6 that at the initial stage of the communication, the Server instance 12 starts up and thus may initialize the web service process. At this stage the server instance 12 preferably waits for connections of at least one client instance 14 and is configured to receive requests from the at least one client instance 14 and to respond accordingly. The server instance 12 is configured to authorize the client instance 14 to the system by verifying its digital certificate and return true or false value. In case that the request of the client instance 14 is invalid, the request will be dropped by the server instance 12.

In case that the request of the client instance 14 is valid, the server instance 12 is further configured to analyze the type of the received request and proceed to the corresponding action.

In accordance to the embodiments of the present invention, the corresponding action may be divided into three different processes.

The first process “GetSchedule” builds a generic advertisement schedule based on available multimedia package and relative weighting. The first process “Getshedule” receives the client instance 14 ID, pulls the profile of the mobile device user from the database and filters promotional content based on the interface elements that the mobile user has selected, such as an incoming call, a ringtone, an outgoing call image, message background, main background or any other interface element. The first process “GetShedule” then returns a custom advertising schedule for the specific client instance 14.

The second process “GetAsset” receives a certain asset comprising of multimedia package with an ID and verifies whether the asset has the necessary identifier and whether it exists in the asset database and if the asset exists, it may be then retrieved from the database and served to the client instance 14.

The third process “Statistics” receives a digitally signed statistics package from the client instance 14 and validates the digital signature of the statistics package. In case that the statistics package is valid and within the range of expected results, the statistics are imported into the database and confirmation message is returned to the client instance 14 to indicate that the request has been processed successfully. The “Statistics” indicate the amount of the mobile device user actions.

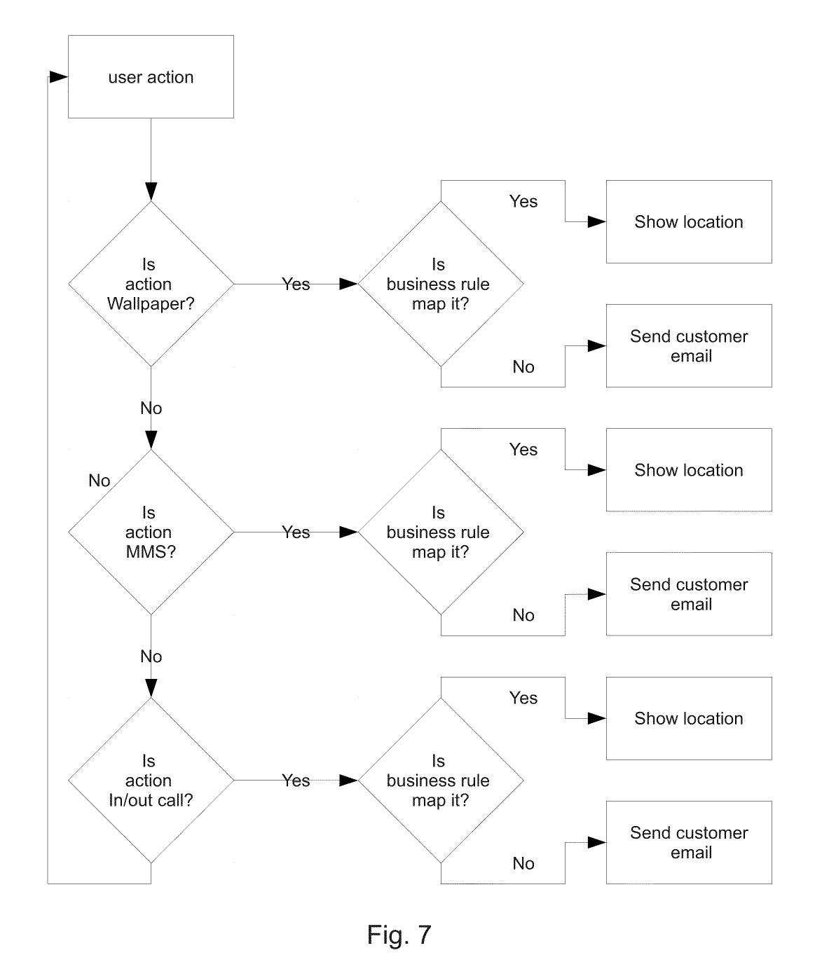

Reference is now made to FIG. 7, which is a simplified flow chart illustration of the client instance operation of the mobile wireless communication system of FIG. 1.

It is seen on FIG. 7 what is the result that can be triggered by an action of the mobile device user. The action of the mobile device user may be comprised of using any interface element of the mobile device, such as for example tapping on a visual promotional content, which can result in TagIT or MapIT response, while TagIT will result in the mobile device user receiving an email with promotional content and MapIT will result in showing a map with a physical address of the relevant branding partner.

In accordance with the embodiments of the present invention, in case that the mobile device user activates a wall paper interface element, business rule will be verified with the server instance 12 and in case that a suitable multimedia package based on mobile device user profile or schedule is found in the database, a map with a geographical location of the branding partner will be shown and provide a MapIT response. In case that no suitable multimedia package is found in the server instance 14 database, TagIT response will be provided and the mobile device user will receive an email with a promotional content from the server instance 12.

Similarly, in case that the mobile device user activates an MMS interface element, business rule will be verified with the server instance 12 and in case that a suitable multimedia package based on mobile device user profile or schedule is found in the database, a map with a geographical location of the branding partner will be shown and provide a MapIT response. In case that no suitable multimedia package is found in the server instance 14 database, TagIT response will be provided and the mobile device user will receive an email with a promotional content from the server instance 12.

Additionally, in case that the mobile device user activates an incoming call ringtone or outgoing call image interface elements, business rule will be verified with the server instance 12 and in case that a suitable multimedia package based on mobile device user profile or schedule is found in the database, a map with a geographical location of the branding partner will be shown and provide a MapIT response. In case that no suitable multimedia package is found in the server instance 14 database, TagIT response will be provided and the mobile device user will receive an email with a promotional content from the server instance 12.

It is appreciated that any other interface element of the mobile device can be activated in a similar manner.

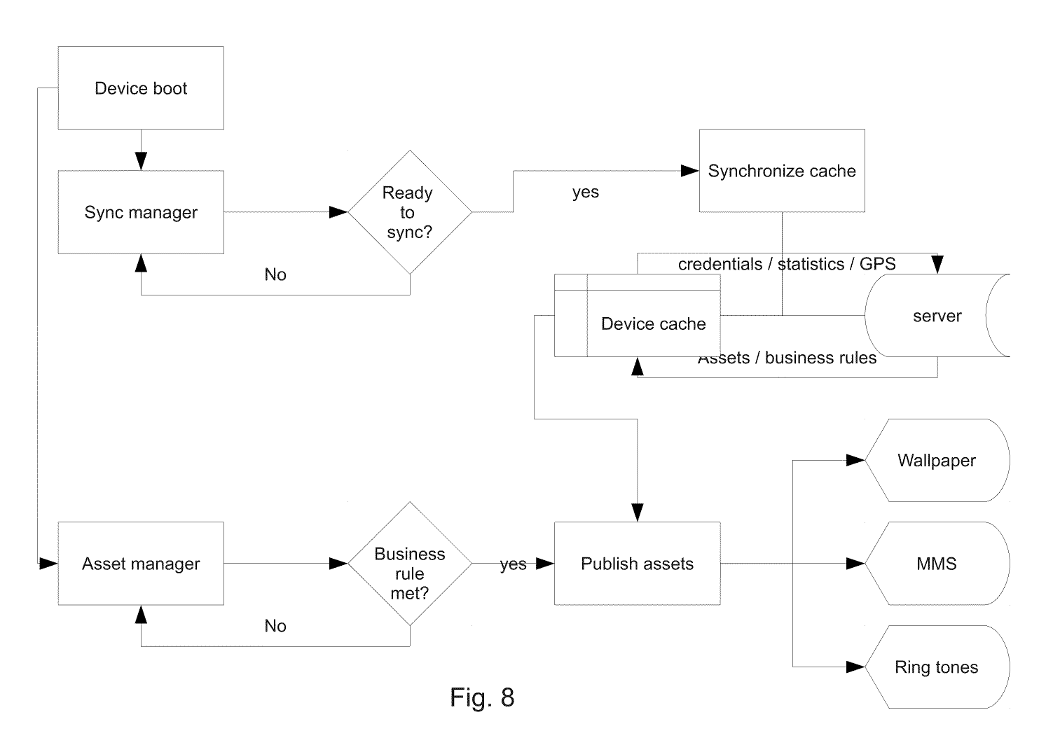

Reference is now made to FIG. 8, which is a simplified flow chart illustration of the communication process of the mobile wireless communication system of FIG. 1.

It can be seen in FIG. 8 that once the client instance 14, preferably a mobile device, is turned on a signal is provided to the sync manager that is preferably located on the mobile device and is configured to decide whether the mobile device is ready to download the list of assets from the server instance 12 and synchronize the assets with its local asset cache. The local asset cache of the mobile device is preferably comprised of a folder that stores or local assets of the mobile device, such as GPS location, statistics and user profile. The list of assets on the server instance 12 is preferably comprised of the downloaded assets from the branding partners and business rules, which will be described more precisely further.

The asset manager is preferably located on the server instance 12 and is configured to manage the communication between the client instance 14 and the server instance 12 and provide a process that dictates which asset should be used or what interface elements should be altered on the mobile device in accordance to a business rule.

The business rule may be based on several criteria, such as verifying the schedule created for the specific mobile device user, the profile of the business device user and the ID of the client instance 14. In case that the business rule has been met, then the assets can be published to the mobile device and one or several of the interface elements of the mobile device, such as a wallpaper, MMS, ringtone or any other interface element of the mobile device may be altered without any action taken by the mobile device user.

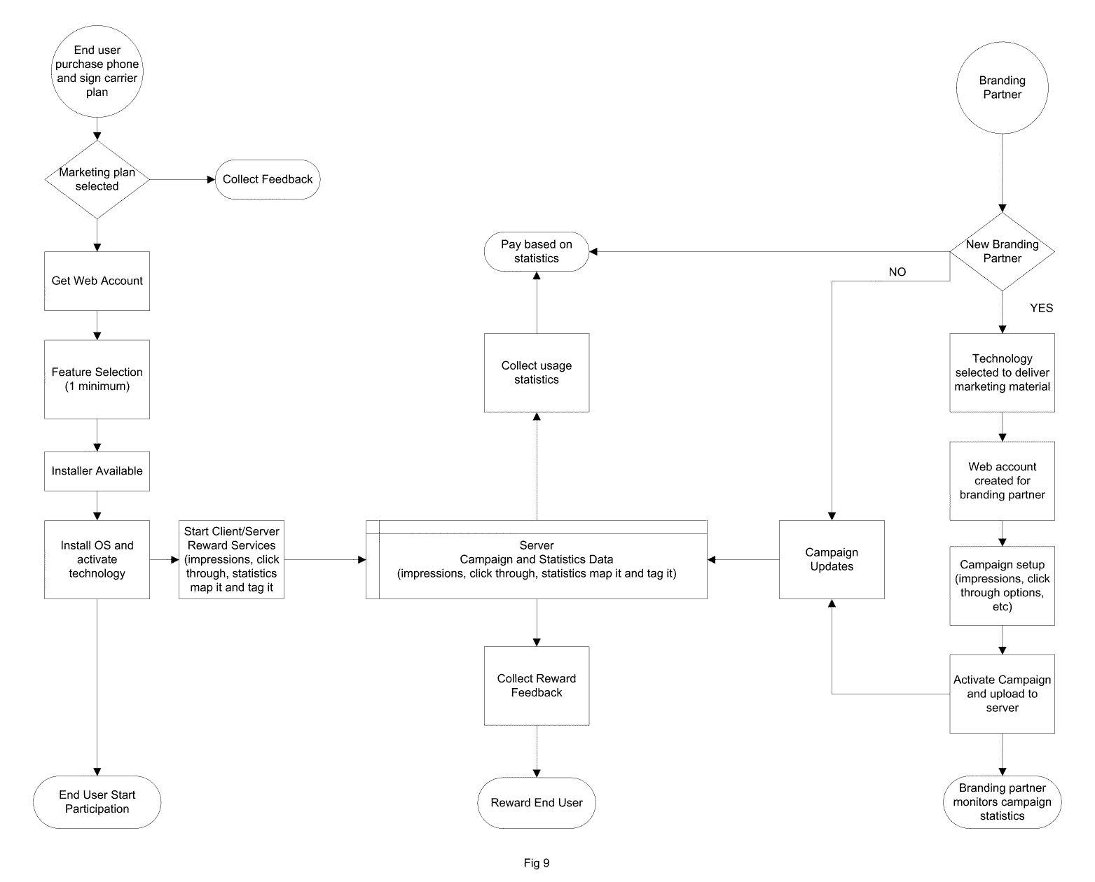

Reference is now made to FIG. 9, which is a simplified flow chart illustration of the business model in accordance with a preferred embodiment of the invention.

FIG. 9 provides a schematic structure of the business model used in accordance to the embodiments of the proposed mobile wireless communication system. Both branding partner side and a mobile device user side are shown in FIG. 9 and the interrelation between them and the owner of the mobile wireless communication system.

It can be seen that the branding partner chooses the technology of the mobile wireless communication system owner in order to be able to market its goods or services through the server instance 12 and the client instance 14.

It can also be seen that the mobile device user chooses the technology of the mobile wireless communication system owner and further selects some of the interface elements for sponsorship. Once the mobile device user chooses the technology, a dedicated operating system may be installed on the mobile device.

The server instance 12 intermediates between the mobile device user and the branding partner and contains both the multimedia packages with promotional data of the branding partners and the statistics data that indicate the amount of actions taken by the mobile device user.

It is appreciated that if the business rule was met and the mobile device user received either MapIT or TagIT response from the server instance 12, he receives a reward for using the technology. The mobile wireless communication system owner may be paid by the branding partner based on the statistics data on the server instance 12, which indicates the amount of actions taken by the mobile device user.

It will be appreciated by persons skilled in the art that the present invention is not limited by what has been particularly shown and described hereinabove. Rather the scope of the present invention includes both combinations and sub combinations of various features described hereinabove as well as variations and modifications thereof which are not in the prior art.

1. A mobile wireless communication system, comprising:
a. a mobile device having a plurality of interface elements;
b. a query server configured to obtain data from the mobile device and generate a processed data;
c. a content server configured to store a multimedia content, wherein the content server is configured to obtain the processed data from the query server and choose the multimedia content according to the processed data, and wherein the multimedia content chosen according to the processed data configured to be wirelessly transmitted to the mobile device and alter at least one of the plurality of interface elements.

2. The mobile wireless communication system according to claim 1, wherein the processed data is configured to be wirelessly transmitted via Wi-Fi network.

3. The mobile wireless communication system according to claim 1, wherein the query server is configured to periodically obtain data from the mobile device.

4. The mobile wireless communication system according to claim 1, wherein the query server configured to obtain a user profile data from the mobile device.

5. The mobile wireless communication system according to claim 1, wherein the query server configured to obtain a geographic location of the mobile device.

6. The mobile wireless communication system according to claim 1, wherein the plurality of interface elements may be chosen from the group comprising: background image, ringtone, incoming call image, outgoing call image and speed dial.

7. The mobile wireless communication system according to claim 1, wherein the mobile device user is precluded from altering at least one of the plurality of interface elements.

8. The mobile wireless communication system according to claim 1, wherein the content server is configured to match a suitable multimedia content, based on the processed data obtained from the query server.

9. A mobile wireless communication device, comprising:
a. a mobile device having a plurality of interface elements and
b. software configured to be associated with the mobile device, wherein the software is configured to:
i. obtain data from at least one remote server;
ii. alter at least one of the plurality of interface elements according to the data obtained from at least one remote server; and
iii. preclude the mobile device user from changing the at least one of the plurality of interface elements altered according to the data obtained from the at least one remote server.

10. The mobile wireless communication device, according to claim 9, wherein the software is configured to obtain an encrypted data from the at least one remote server.

11. The mobile wireless communication device, according to claim 10, wherein the software is configured to decrypt the data obtained from the at least one remote server.

12. The mobile wireless communication device, according to claim 11, wherein the software is configured to override at least one of the plurality of interface elements of the mobile device.

13. The mobile wireless communication device, according to claim 12, wherein the software is configured to install the data obtained from the at least one remote server into the overridden interface elements.

14. The mobile wireless communication system according to claim 9, wherein the at least one remote server may include a query server.

15. The mobile wireless communication system according to claim 9, wherein the at least one remote server may include a content server.

16. The mobile wireless communication system according to claim 9, wherein the plurality of interface elements may be chosen from the group comprising background image, ringtone, incoming call image, outgoing call image, and speed dial.

17. The mobile wireless communication system according to claim 9, wherein the software may be downloaded from a remote server.

18. A method of providing renting advertising space, comprising the steps of providing a mobile device having a plurality of interface elements and a software configured to be associated with the mobile device, wherein the software is configured to alter the mobile device interface elements, the interface elements are configured to be altered according to data provided by a remote server, and wherein the mobile device user compensation is calculated based on the amount of interface element alternations.

19. The method of providing renting advertising space, according to claim 18, wherein the software may be downloaded from a remote server.

20. The method for altering mobile device interface elements, according to claim 18, wherein the software may be installed by the mobile device user.
